(19) United States
(12) Patent Application Publication
(10) Pub. No.: US 2003/0094559 A1
(43) Pub. Date: May 22, 2003

(54) Disk-shaped christmas-tree stand

(76) Inventor: Klaus Krinner, Strasskirchen (DE)

Correspondence Address: JORDAN AND HAMBURG LLP, 122 EAST 42ND STREET, SUITE 4000, NEW YORK, NY, 10168, US

(21) Appl. No.: 09/937,744

(22) PCT Filed: Jan. 24, 2001
(86) PCT No.: PCT/EP01/00750

(30) Foreign Application Priority Data
Feb. 1, 2000 (DE) 10004312.7

(51) Int. Cl. F16M 13/00

(52) U.S. Cl. 248/523

(57) ABSTRACT

The invention relates to a stand for clamping rod-shaped structures, in particular Christmas trees. The stand has a tensioning and holding device, a housing, and a water container. The tensioning and holding device can be moved from a first position to a second position, the rod-shaped structure being held in the first position, and the tensioning and holding device, in the second position, being lowered into the water container. The width to height ratio of the water container is greater than 2.5:1, and the width to height ratio of the housing corresponds substantially to that of the water container.

The invention relates to a stand for clamping rod-shaped structures, in particular Christmas trees, with a tensioning and holding device, a housing, and a water container.

From the prior art, a great many stands are known for clamping rod-shaped structures, these stands being higher than they are wide. Recently, such stands have been provided with a container which can be filled with water and whose height to width proportion or, in the case of a stand with a round support surface, height to diameter proportion, is between 2:1 and 1:2. The shape of the water containers being in most cases substantially higher than it is wide, a large part of its holding volume is taken up by the trunk when said stand is used, for example, to hold a Christmas tree, with the result that only a relatively small volume remains for filling with water. With large Christmas trees especially, it was therefore necessary to refill the container frequently with more water.

In addition, this design of the stand in the above-described height to width ratios had the disadvantage that the relatively small stand surfaces in relation to height and the small water volume of the stands could not provide sufficient stability of the stand when it was used to clamp particularly high structures or Christmas trees. This is especially true given the plastic materials which are being increasingly used to produce stands and which, although permitting lower production costs, are nevertheless very light.

It is therefore the object of the present invention to produce a stand for clamping rod-shaped structures, which stand has such a form that as large as possible a water volume can be obtained along with a high degree of stand stability, but which stand is also practical to handle and can be easily stowed away for storage purposes.

According to the invention, the object is achieved by a stand having the features as claimed in claim 1. Preferred illustrative embodiments of the stand according to the invention are set out in the dependent claims.

The stand according to the invention for clamping rod-shaped structures has a tensioning and holding device, a housing, and a water container. According to the invention, the width to height ratio of the water container is greater than 2.5:1 and the width to height ratio of the housing corresponds substantially to that of the water container. With these proportions for the dimensions of the water container and of the housing, almost the entire internal volume of the stand can advantageously be used for receiving water. The flat design with a width to height ratio of greater than 2.5:1 ensures that the water reservoir is optimally used since, in relation to the overall volume, little volume is taken up by the trunk received in the stand or in the water container. The possibility of being able to introduce a lot of water at once into the stand saves the bother of constant refilling, which is very awkward, particularly when large trees are being clamped. The flat shape and the resulting large stand surface ensure that the stand is also extraordinarily secure against tipping over. The stand stability is also enhanced by the fact that the large water reservoir, when filled, substantially increases the total weight of the stand. In addition, the flat design means that the stand can be adapted to pallet size. The tensioning and holding device can be moved from a first position, in which the rod-shaped structure is held, into a second position in which the tensioning and holding device is lowered into the water container. The advantage of this is that, when the stand is not in use, lowering the tensioning and holding device into the water container means that said stand is easier to store and takes up less space.

A flat stand shape of this kind results in a typical disk-shaped stand with a tensioning device for the holding elements which is easy to operate and which permits secure holding of the trunk for rapid and simple setting-up of the trunk.

In a preferred embodiment, the housing covers at least part of the water container. The part of the housing covering the water container is designed as an overflow protection or spillage protection. This affords the advantage that if, for example, the set-up stand is moved or inadvertently knocked, water which has been introduced into the water container does not spill directly over and run onto the floor.

The housing and the water container are preferably connected in a watertight manner at a common connection point so that, even when the container is filled completely with water, the water cannot run out.

In a further advantageous embodiment, the housing and the water container are made of plastic so that material and production costs are kept low. In addition, the flat disk-shaped design and the use of plastic permit particularly simple manufacture and also a thin-walled design of the housing walls and water container walls, which in turn results in the stand having a greater water-holding capacity. Moreover, the use of plastic makes it possible to connect the housing and the water container preferably by hot-plate welding, which affords a durable, secure and tight connection.

However, the connection between housing and water container can also be obtained by adhesive bonding, for example by means of a special plastics adhesive. A further possibility for obtaining the necessary connection would be to provide a plug and socket connection for this purpose.

In a particularly preferred embodiment, the housing and the water container have approximately identical volumes. This has the advantage that almost the entire internal volume of the housing serves as a water reservoir and there is no or very little unused space between housing and water container.

The wall of the housing and the wall of the water container preferably delimit a cavity which is used for receiving filler material. The cavity is filled for example with a filler material heavier than water and one which can preferably set, giving the stand still more stability and safety.

Tn a further preferred embodiment, the housing additionally has a base plate. The base plate can for example be provided, on its surface resting on the ground, with gripping devices to ensure that the set-up stand cannot slip on smooth floors or supports.

According to another preferred embodiment, the housing and the water container are made integral. This design further reduces the production costs.

The tensioning and holding device in the second position can preferably be lowered completely into the water container so that the stand can be easily packed away, for example in flat boxes, and also needs little space for its storage.

The width to height ratio of the water container is preferably in the range of 3:1 to 12:1, in particular 6:1 to 9;1.

Given a width to height ratio of 3:1, this means that a stand with a width of 48 cm will have a height of 16 cm, or, in the case of a maximum width to height ratio of 12:1, and with the same width (48 cm), it will have a height of 4 cm.

In illustrative embodiments which lie in the width to height ratio range indicated above, a further advantage lies in the fact that a water level indicator provided on the housing can be arranged so that it can be clearly seen, i.e. as far away as possible from the center point of the stand.

The invention is explained below on the basis of an embodiment and with reference to the attached drawings, in which:

FIG. 1 shows a cross-sectional view through a stand known from the prior art;

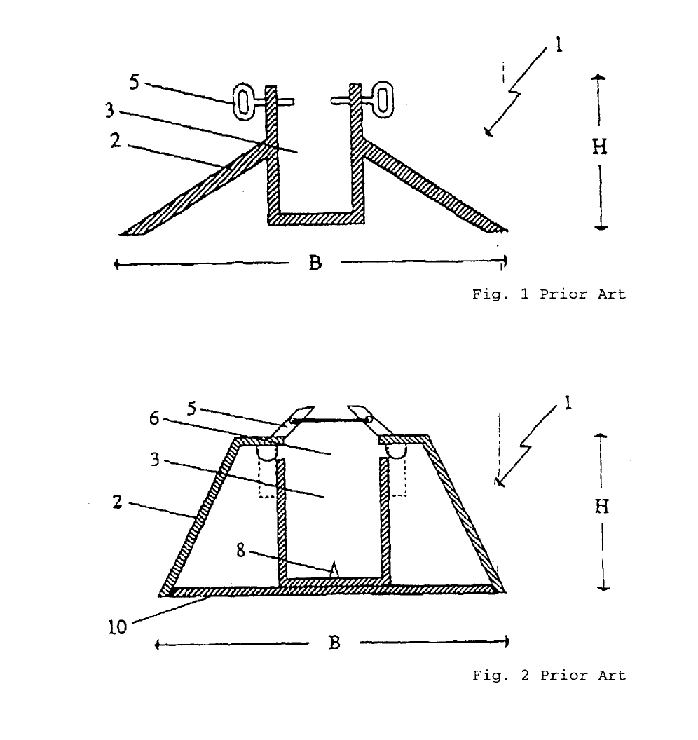

FIG. 2 shows a cross-sectional view through another stand known from the prior art;

FIG. 3 shows a cross-sectional view through an illustrative embodiment of the stand according to the invention;

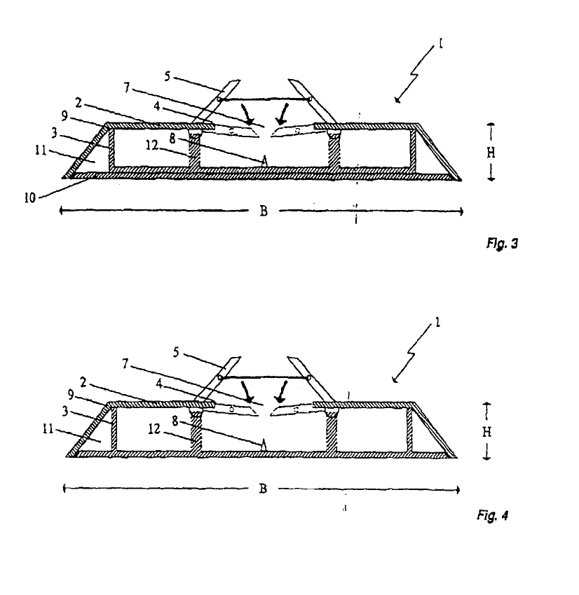

FIG. 4 shows a cross-sectional view through another illustrative embodiment of the stand according to the invention;

FIG. 5 shows a diagrammatic cross-sectional view through yet another illustrative embodiment of the stand according to the invention;

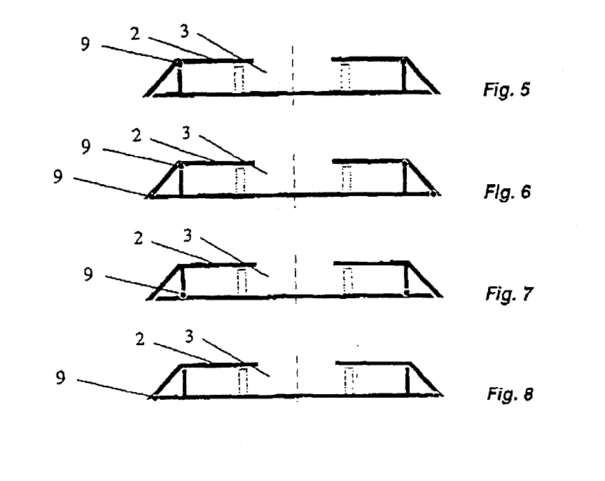

FIG. 6 shows a diagrammatic cross-sectional view through yet another illustrative embodiment of the stand according to the invention;

FIG. 7 shows a diagrammatic cross-sectional view through yet another illustrative embodiment of the stand according to the invention;

FIG. 8 shows a diagrammatic cross-sectional view through yet another illustrative embodiment of the stand according to the invention.

A conventional stand 1 known from the prior art is shown in cross section in FIG. 1. Here, the water container 3 is made integral with the housing 2. Thumb screws arranged on the water container 3 are provided as a holding device 5. The basic form of this stand is rather compact and offers only a small filling volume for water.

A cross-sectional view of another stand 1 known from the prior art is shown in FIG. 2. The stand 1 has a housing 2 which is placed on a base plate 10. The base plate 10 has a substantially circular surface. The housing 2 is provided at its top with a round opening 6. Arranged centrally in the inside of the housing there is a cylindrical water container 3 which has a centering spike 8 for securing a rod-shaped structure (not shown). The diameter of the water container 3 corresponds to the diameter of the opening 6 of the housing 2. The wall of the water container 3, the wall of the housing 2 and the base plate 10 delimit a cavity 11 whose volume is distinctly greater than the volume of the water container 3. Arranged on the housing 2, and projecting into the inside of the water container 3, there is a tensioning and holding device 5 for tensioning and holding a rod-shaped structure. The ratio of the maximum diameter of the housing to its height is much smaller than that according to the invention. The basic form of this known stand is not disk-shaped, but compact.

A cross-sectional view of the stand 1 according to the invention is shown in FIG. 3. A housing 2 sits on a circular base plate 10. A water container 3 with a centering spike 8 is arranged in the housing 2. The housing 2 and the water container 3 are firmly connected to each other at a connection point 9. The wall of the housing 2 extends over an opening 7 of the water container 3 and thereby forms an overflow protection 4. The wall of the housing 2, the wall of the water container 3 and the base plate 10 delimit a cavity 11 whose volume is distinctly smaller than the volume of the water container 3. Webs 12, which serve for reinforcing purposes, are made integral with the water container 3. A clamping and holding device 5 is also shown which, in a first position for holding the rod-shaped structure, can be swiveled into a second position (broken line) into the water container 3. The stand 1 is designed flat, the ratio of the maximum housing diameter to the height of the housing being approximately 5:1.

FIG. 4 shows a further illustrative embodiment of the stand according to the invention. This is in principle the same arrangement and basic form as shown in FIG. 3. The difference from the stand shown in FIG. 3 is that the stand 1 shown in FIG. 4 has no separate base plate 10. In this illustrative embodiment, the base of the stand 1, or its surface resting on a support, is designed as an integral component part of the water container 3.

FIGS. 5 to 8 showing diagrammatic views of further illustrative embodiments of the stand 1 according to the invention are intended to make clear the possible ways of providing the connection between housing 2 and water container 3 The stand 1 shown diagrammatically here corresponds in principle to the illustrative embodiment represented in FIG. 4 without a separate base plate 10. The connection point or points (there are 2 connection points in the illustrative embodiment shown in FIG. 6) between housing 2 and water container 3 are designated here by the reference number 9.

List of Reference Numbers

1 stand

2 housing

3 water container

4 overflow protection

5 tensioning and holding device

6 opening of the housing

7 opening of the water container

8 centering spike

9 connection point

10 base plate

11 cavity

12 web

1. A stand (1) for clamping rod-shaped structures, in particular Christmas trees, with a tensioning and holding device (5) which can be swiveled between a first position and a second position, a housing (2), and a water container (3), characterized in that the width to height ratio of the water container (3) is greater than 2.5:1, and the width to height ratio of the housing (2) corresponds substantially to that of the water container (3), where the tensioning and holding device (5), in the first position, holds the rod-shaped structure, and, in the second position, the tensioning and holding device (5) is lowered into the water container (3).

2. The stand (1) as claimed in claim 1, characterized in that the housing (2) covers at least part of the top of the water container (3) as an overflow protection (4).

3. The stand (1) as claimed in claim 1 or 2, characterized in that the housing (2) and the water container (3) have at least one common connection point (9) at which the water container (3) is connected to the housing (2) in a watertight manner.

4. The stand (1) as claimed in one of claims 1 through 3, characterized in that the housing (2) and the water container (3) are made of plastic and have thin walls.

5. The stand (1) as claimed in one of claims 1 through 4, characterized in that the housing (2) and the water container (3) are connected to each other by hot-plate welding.

6. The stand (1) as claimed in one of claims 1 through 5, characterized in that the housing (2) and the water container (3) have approximately identical volumes.

7. The stand (1) as claimed in one of claims 1 through 6, characterized in that the wall of the housing (2) and the wall of the water container (3) delimit a cavity (11) for receiving filler material.

8. The stand (1) as claimed in one of claims 1 through 7, characterized in that the housing (2) additionally has a base plate (10).

9. The stand (1) as claimed in one of claims 1 through 4, characterized in that the housing (2) and the water container (3) are made integral.

10. The stand (1) as claimed in one of claims 1 through 9, characterized in that the tensioning and holding device (5) in the second position can be lowered completely into the water container (3).

11. The stand (1) as claimed in one of claims 1 through 10, characterized in that the width to height ratio of the water container (3) lies in the range of 3:1 to 12:1, in particular 6:1 to 9:1.

12. The stand (1) as claimed in one of claims 1 through 11, characterized in that a water level indicator is provided on the housing.
